(19) United States
(12) Patent Application Publication
(10) Pub. No.: US 2026/0091838 A1
(43) Pub. Date: Apr. 2, 2026

(54) SADDLE-RIDE VEHICLE

(71) Applicant: TOYOTA JIDOSHA KABUSHIKI KAISHA, Toyota-shi (JP)

(72) Inventor: Chiaki KATAOKA, Nagakute-shi (JP)

(73) Assignee: TOYOTA JIDOSHA KABUSHIKI KAISHA, Toyota-shi (JP)

(21) Appl. No.: 19/332,506

(22) Filed: Sep. 18, 2025

(30) Foreign Application Priority Data
Oct. 2, 2024 (JP) 2024-173268

(51) Int. Cl. B62J 35/00; B62K 11/02

(52) U.S. Cl. CPC B62J 35/00; B62K 11/02

(57) ABSTRACT

In a saddle-ride vehicle, an attachment and detachment device is disposed in a place that is between a front fork and a rear suspension and that is below a seat of the saddle-ride vehicle, the hydrogen tank is mountable on the attachment and detachment device, and the attachment and detachment device is operable such that at least an attachment and detachment portion of the hydrogen tank is positioned outside a frame of the saddle-ride vehicle when the hydrogen tank is detached or attached.

### CROSS-REFERENCE TO RELATED APPLICATION

This application claims priority to Japanese Patent Application No. 2024-173268 filed on Oct. 2, 2024. The disclosure of the above-identified application, including the specification, drawings, and claims, is incorporated by reference herein in its entirety.

### BACKGROUND

### 1. Technical Field

The present specification discloses a technology relating to a saddle-ride vehicle. In particular, the present specification discloses a technology relating to a saddle-ride vehicle on which a hydrogen tank is mounted.

### 2. Description of Related Art

Japanese Unexamined Patent Application Publication No. 2007-99059 (JP 2007-99059 A) discloses a two-wheeled motorcycle (saddle-ride vehicle) on which a hydrogen tank is mounted. In the saddle-ride vehicle in JP 2007-99059 A, an attachment and detachment device for mounting the hydrogen tank is disposed above a rear wheel. In JP 2007-99059 A, after fuel (hydrogen) in the hydrogen tank is consumed, the hydrogen tank is removed from the attachment and detachment device, and a new hydrogen tank filled with hydrogen is attached. In JP 2007-99059 A, the amount of refilling time of the fuel can be shortened by using a cartridge-type hydrogen tank.

### SUMMARY

As described above, in JP 2007-99059 A, the attachment and detachment device for mounting the hydrogen tank is disposed above the rear wheel. When the attachment and detachment device and the hydrogen tank are positioned above the rear wheel, the center of gravity of the saddle-ride vehicle becomes higher, and there are cases in which the operability of the saddle-ride vehicle decreases. Meanwhile, when the attachment and detachment device and the hydrogen tank are disposed on the inside of the saddle-ride vehicle, the attachment and detachment properties of the hydrogen tank decreases, and the replacement operation of the hydrogen tank (the amount of refilling time of the fuel) becomes longer. Therefore, a technology of inhibiting the center of gravity of the saddle-ride vehicle from becoming higher and improving the attachment and detachment properties of the hydrogen tank is needed. An object of the present specification is to provide a saddle-ride vehicle in which the attachment and detachment properties of the hydrogen tank is satisfactory and the center of gravity is low.

A first aspect disclosed in the present specification relates to a saddle-ride vehicle on which a detachable and attachable hydrogen tank is mounted. In the saddle-ride vehicle, an attachment and detachment device may be disposed in a place that is between a front fork and a rear suspension and that is below a seat of the saddle-ride vehicle, the hydrogen tank may be mountable on the attachment and detachment device, and the attachment and detachment device may be configured to operate such that at least an attachment and detachment portion of the hydrogen tank is positioned outside a frame of the saddle-ride vehicle when the hydrogen tank is detached or attached.

In the configuration described above, the hydrogen tank is disposed below the seat, and hence it is possible to lower the center of gravity of the saddle-ride vehicle. As a result, it is possible to improve the operability of the saddle-ride vehicle. When the hydrogen tank is attached or detached, the attachment and detachment device is operated such that an attachment and detachment part of the hydrogen tank is positioned on the outside of the frame, and hence it is possible to easily perform attachment and detachment (removement and installment) of the hydrogen tank. As a result, it is possible to perform the replacement operation of the hydrogen tank in a short amount of time. When the hydrogen tank is disposed in the position described above, it is possible to effectively use the space above the rear wheel. Specifically, it is possible to secure the space of a passenger or secure the space in which luggage is loaded.

In the second aspect, the attachment and detachment device may be disposed in a center tunnel provided in the frame in the first aspect described above.

With the configuration described above, the hydrogen tank is inhibited from being exposed to the outside, the collision safety is improved, the hydrogen tank is inhibited from coming into contact with the road surface at the time of falling, and it is possible to reduce damage to the hydrogen tank.

In a third aspect, the attachment and detachment device may be pivotally attached to the frame in the first or second aspect described above.

With the configuration described above, it is possible to change the angle of the attachment and detachment device (hydrogen tank) with respect to the frame when the hydrogen tank is attached and detached. The attachment and detachment part of the hydrogen tank faces the side of the saddle-ride vehicle, and hence it is possible to smoothly perform the attachment and detachment of the hydrogen tank.

In a fourth aspect, the attachment and detachment device may be integrated with the seat in any of the first to third aspects described above.

With the configuration described above, the attachment and detachment device and the seat are integrated, and hence it is possible to reduce the number of parts configuring the saddle-ride vehicle. There is no need to provide a gap between the attachment and detachment device and the seat, and it is possible to reduce the height of the seat. As a result, it is possible to lower the center of gravity of the saddle-ride vehicle including a rider when the saddle-ride vehicle is ridden.

In a fifth aspect, the attachment and detachment device may be attached to be moved in a sliding manner with respect to the frame in the first or second aspect described above.

With the configuration described above, it is possible to move the entire hydrogen tank to the outer side of the frame when the hydrogen tank is attached or detached. Therefore, the freedom of the structure of removing the hydrogen tank from the attachment and detachment device (or installing the hydrogen tank into the attachment and detachment device) is increased. As a result, it is possible to increase the degree of freedom of the design of the saddle-ride vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows an external view (side view) of a saddle-ride vehicle;

FIG. 2 shows a frame external view (side view) of the saddle-ride vehicle;

FIG. 3 shows a plan view of the saddle-ride vehicle;

FIG. 4 shows a sectional view of an attachment and detachment device and a hydrogen tank;

FIG. 5 is an operation explanatory view when the hydrogen tank is attached and detached;

FIG. 6 shows an external view of the attachment and detachment device and the hydrogen tank;

FIG. 7 shows a sectional view of a modified example of an attachment and detachment device and a hydrogen tank; and

FIG. 8 shows an operation explanatory view when the hydrogen tank is attached and detached in the modified example.

### DETAILED DESCRIPTION OF EMBODIMENTS

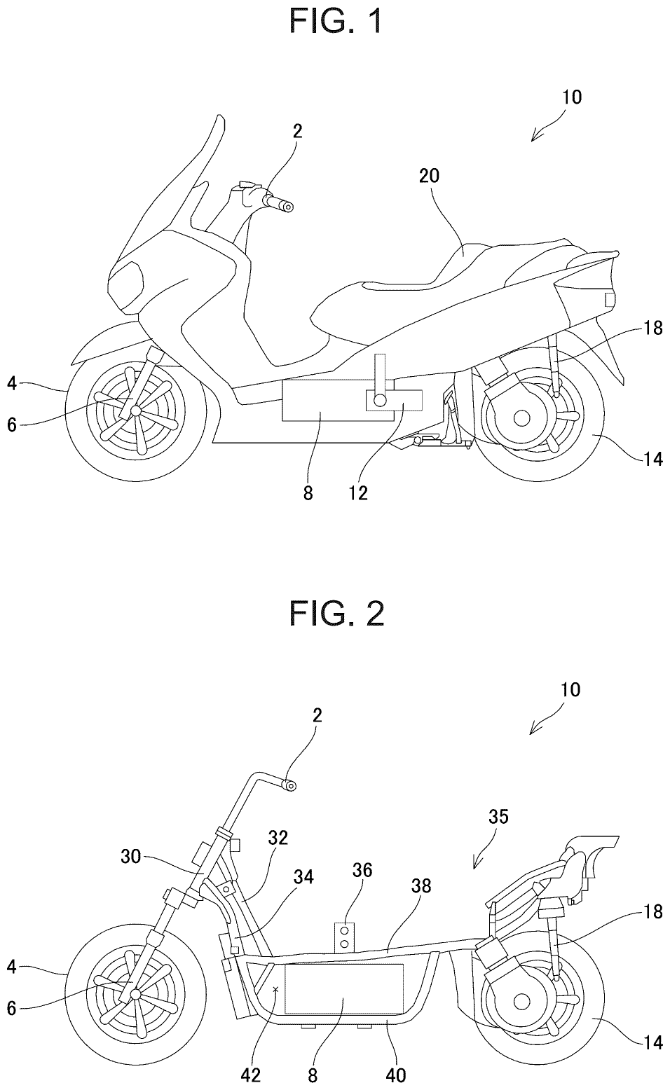

With reference to FIG. 1 to FIG. 3, a saddle-ride vehicle 10 is described. The saddle-ride vehicle 10 is a two-wheeled motorcycle and is a fuel cell electric vehicle of which fuel source is hydrogen. An example of a two-wheeled motorcycle is described in the present embodiment, but the technology disclosed in the specification can also be applied to a three-wheeled motorcycle. The technology relating to the present specification can also be applied to a hydrogen engine vehicle of which fuel source is hydrogen.

As shown in FIG. 1, the saddle-ride vehicle 10 includes a seat 20 on which a rider sits, a front wheel 4, and a rear wheel 14. The saddle-ride vehicle 10 includes handlebars 2 for operating the front wheel 4, a front fork 6 for reducing the vibration of the front wheel 4, and a rear suspension 18 that reduces the vibration of the rear wheel 14. The handlebars 2, the front fork 6, and the rear suspension 18 are attached to a frame 35 described later.

An attachment and detachment device 8 including a lock mechanism 12 is provided below the seat 20. The attachment and detachment device 8 is disposed between the front fork 6 and the rear suspension 18. The hydrogen tank 60 described later can be mounted on the attachment and detachment device 8, and the attachment and detachment device 8 is attached to the frame 35 described later. It can be understood that the attachment and detachment device 8 is disposed between the front wheel 4 and the rear wheel 14 in the front-rear direction (the direction connecting the front wheel 4 and the rear wheel 14 to each other) of the saddle-ride vehicle 10.

FIG. 2 shows a view in which the exterior and the like of the saddle-ride vehicle 10 are removed. With reference to FIG. 2, the structure of the frame 35 of the saddle-ride vehicle 10 and the position in which the attachment and detachment device 8 is disposed are described in detail. The frame 35 includes a head pipe 30, a first down frame 32, a second down frame 34, upper frames 38, and lower frames 40. The head pipe 30 is hollow, and a steering shaft (not shown) that extends from the handlebars 2 passes through the head pipe 30. The steering shaft is connected to the front fork 6. Therefore, when the handlebars 2 are operated, the angle of the front wheel 4 with respect to the frame 35 changes.

One end of the first down frame 32 and one end of the second down frame 34 are fixed to the head pipe 30. The other end of the first down frame 32 and the other end of the second down frame 34 are fixed to the upper frames 38. The upper frames 38 extend in the front-rear direction of the saddle-ride vehicle 10, and the rear suspension 18 is fixed to rear parts of the upper frames 38. Support metal fittings 36 for attaching the seat 20 are attached to the upper frames 38. Front parts of the lower frames 40 are curved upward, and front ends thereof are fixed to front ends of the upper frames 38. Rear parts of the lower frames 40 are also curved upward, and rear ends thereof are fixed to intermediate portions of the upper frames 38 in the front-rear direction.

A center tunnel 42 is formed in an intermediate portion of the saddle-ride vehicle 10 in the front-rear direction thereof by the upper frames 38 and the lower frames 40. The attachment and detachment device 8 is disposed on the inside of the center tunnel 42. The upper frames 38 are provided so as to form a pair in the left-right direction (the direction orthogonal to the front-rear direction) of the saddle-ride vehicle 10 and are connected to each other by connecting frames 52, 54 described later. The lower frames 40 are provided so as to form a pair in the left-right direction of the saddle-ride vehicle 10 and are connected to each other by connecting frames 52, 54 described later. Therefore, the center tunnel 42 is a three-dimensional space, and it can be understood that the attachment and detachment device 8 is disposed in a protected space surrounded by the frames 38, 40, 52, 54.

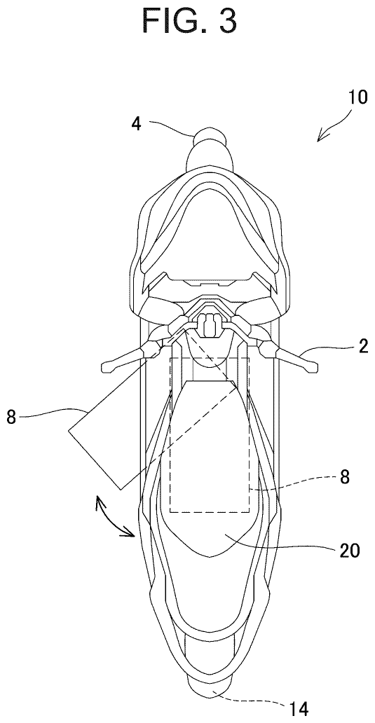

As shown in FIG. 3, the attachment and detachment device 8 pivots about a front end portion, and a rear end portion can be positioned on the outer side relative to side surfaces of the saddle-ride vehicle 10 (in other words, the outside of the frame 35). Only the attachment and detachment device 8 is shown to pivot in FIG. 3 in order to clarify the drawing, but the attachment and detachment device 8 and the seat 20 integrally pivot in practice. In other words, the attachment and detachment device 8 and the seat 20 are fixed to each other.

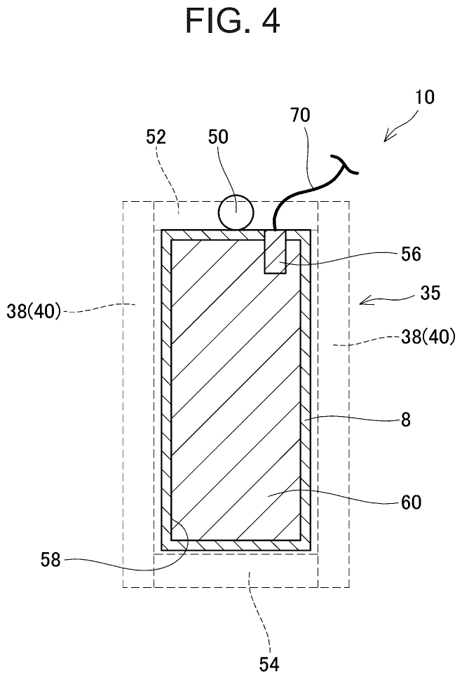

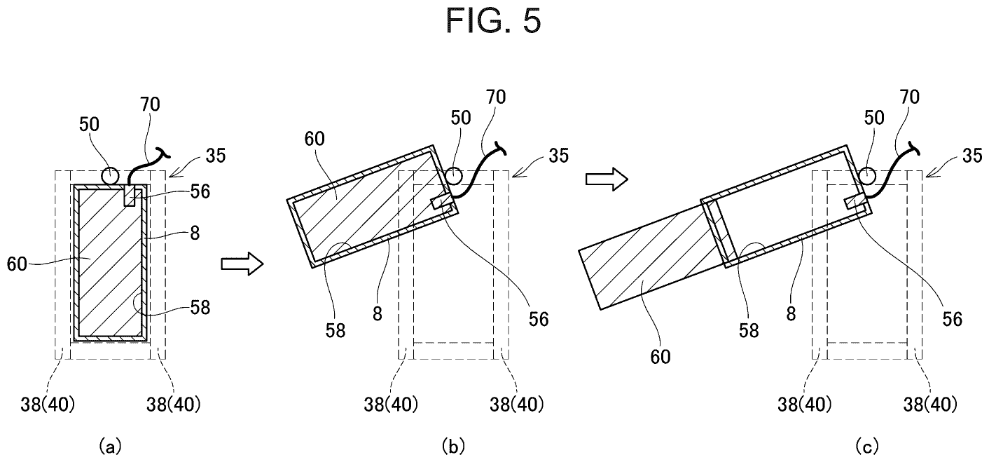

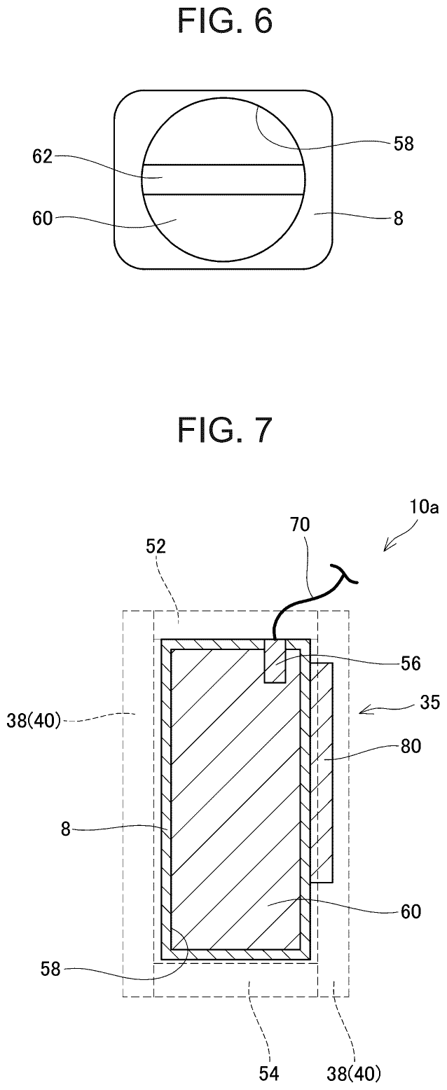

With reference to FIG. 4 to FIG. 6, the attachment and detachment device 8 is described in detail. FIG. 4 and FIG. 5 are equivalent to views in which a section of the attachment and detachment device 8 is observed from above. In FIG. 4 and FIG. 5, only the frame 35 of a part configuring the center tunnel 42 is shown (see also FIG. 2).

As shown in FIG. 4, the pair of upper frames 38 (lower frames 40) is connected to each other by the connecting frames 52, 54. The connecting frame 52 connects the front parts of the upper frames 38 (lower frames 40) to each other. The connecting frame 54 connects the rear parts of the upper frames 38 (lower frames 40) to each other. A rotation shaft 50 that is rotatable with respect to the connecting frame 52 is attached to the connecting frame 52.

The rotation shaft 50 is fixed to the attachment and detachment device 8. Therefore, the attachment and detachment device 8 can pivot with respect to the frame 35 (connecting frame 52). In the saddle-ride vehicle 10, a front part of the attachment and detachment device 8 is fixed to the connecting frame 52. Therefore, when the attachment and detachment device 8 pivots, a rear part of the attachment and detachment device 8 is positioned on the outside of the frame 35. The hydrogen tank 60 is disposed on the inside of the attachment and detachment device 8. The hydrogen tank 60 is inserted into the inside of the attachment and detachment device 8 (taken out to the outside of the attachment and detachment device 8) from an attachment and detachment portion 58 provided in the rear end portion of the attachment and detachment device 8. The attachment and detachment portion 58 is a cylindrical hole extending from the rear end portion toward the front end portion of the attachment and detachment device 8.

A pushrod-ride opening and closing mechanism 56 is fixed to a front end of the attachment and detachment device 8. The opening and closing mechanism 56 can be attached to and detached from the hydrogen tank 60 and can open and close a valve (not shown) of the hydrogen tank 60. The valve of the hydrogen tank 60 is opened when the opening and closing mechanism 56 is connected to the hydrogen tank 60, and the valve of the hydrogen tank 60 is closed when the opening and closing mechanism 56 is disconnected from the hydrogen tank 60. A flexible pipe 70 is connected to the opening and closing mechanism 56. Hydrogen in the hydrogen tank 60 is supplied to a fuel cell (not shown) through the flexible pipe 70.

With reference to FIG. 5, an attachment and detachment method of the hydrogen tank 60 is described. FIG. 5 shows a method of removing the hydrogen tank 60 from the attachment and detachment device 8. Here, (a) shows a state in which the attachment and detachment device 8 is positioned in a predetermined position (on the inside of the center tunnel 42). In this state, the pivoting of the attachment and detachment device 8 is prohibited by the lock mechanism 12 (see also FIG. 1). After the hydrogen in the hydrogen tank 60 is consumed, the hydrogen tank 60 is removed from the attachment and detachment device 8 in order to replace the hydrogen tank 60. First, the lock mechanism 12 is released, and the attachment and detachment device 8 is placed in a pivotable state.

Next, as shown in (b), the attachment and detachment device 8 pivots until the attachment and detachment portion 58 is positioned on the outside of the frame 35 (frames 38, 40) about the rotation shaft 50. At this time, the position of the opening and closing mechanism 56 with respect to the frame 35 changes, and the distance from the opening and closing mechanism 56 to the fuel cell (not shown) changes. However, the opening and closing mechanism 56 and the fuel cell are connected to each other by the flexible pipe 70. Therefore, the flexible pipe 70 can be prevented from being disconnected from the opening and closing mechanism 56 and/or the fuel cell even when the attachment and detachment device 8 pivots.

Next, as shown in (c), the hydrogen tank 60 is pulled out from the attachment and detachment device 8. When the hydrogen tank 60 is pulled out from the attachment and detachment device 8, the opening and closing mechanism 56 is disconnected from the hydrogen tank 60, and the valve of the hydrogen tank 60 is closed. A gripping portion 62 for gripping the hydrogen tank 60 is provided in a rear side end portion of the hydrogen tank 60. When the hydrogen tank 60 is to be pulled out from the attachment and detachment device 8, the gripping portion 62 is gripped, and the hydrogen tank 60 is pulled out. Then, the hydrogen tank 60 that is new and is filled with hydrogen is inserted into the attachment and detachment device 8, and the attachment and detachment device 8 is disposed on the inside of the frame 35 (the inside of the center tunnel 42) in the order of (c), (b), and (a).

As described above, in the saddle-ride vehicle 10, the attachment and detachment device 8 on which the hydrogen tank 60 is mounted is disposed below the seat 20. Therefore, the center of gravity of the saddle-ride vehicle 10 becomes lower, and the operability of the saddle-ride vehicle 10 can be improved. The attachment and detachment device 8 and the seat 20 are integrated. Therefore, the space between the attachment and detachment device 8 and the seat 20 can be reduced, and the center of gravity of the saddle-ride vehicle 10 can be further lowered. The rear part of the seat 20 (the place above the rear wheel 14) can be used as a passenger space or a luggage storage space. The attachment and detachment device 8 (hydrogen tank 60) is disposed between the front fork 6 and the rear suspension 18 (an intermediate part of the saddle-ride vehicle 10 in the front-rear direction), and hence the front-rear weight balance of the saddle-ride vehicle 10 can also be improved.

The attachment and detachment device 8 (hydrogen tank 60) is disposed in the center tunnel 42, and hence the collision safety is improved. The hydrogen tank 60 is inhibited from coming into contact with the road surface at the time of falling, and damage to the hydrogen tank 60 can be reduced.

In the saddle-ride vehicle 10, when the hydrogen tank 60 is attached or detached, the attachment and detachment device 8 is caused to pivot to the left side of the saddle-ride vehicle 10 (see FIG. 5). However, the attachment and detachment device 8 may be caused to pivot to the right side of the saddle-ride vehicle 10. In the saddle-ride vehicle 10, the rotation shaft 50 is fixed to the connecting frame 52 on the front side (see FIG. 4). However, the rotation shaft 50 may be fixed to the connecting frame 54 on the rear side. The attachment and detachment device 8 may be caused to pivot to the left side of the saddle-ride vehicle 10 or may be caused to pivot to the right side of the saddle-ride vehicle 10 in this case as well.

With reference to FIG. 7, a saddle-ride vehicle 10a is described. The saddle-ride vehicle 10a is a modified example of the saddle-ride vehicle 10, and the operation of the attachment and detachment device 8 when the hydrogen tank 60 is attached and detached is different from that of the saddle-ride vehicle 10. Regarding the saddle-ride vehicle 10a, the illustration of the entire vehicle is omitted, and only the frame 35 of a part configuring the center tunnel 42 is shown (corresponding to a part of the saddle-ride vehicle 10 in FIG. 4).

In the saddle-ride vehicle 10a, the rotation shaft 50 is not provided in the connecting frame 52, and a pantograph 80 is disposed between the attachment and detachment device 8 and the frames 38, 40. The pantograph 80 is expandable and contractable, one end is fixed to the attachment and detachment device 8, and the other end is fixed to the frames 38, 40. When the hydrogen tank 60 is to be replaced, the pantograph 80 is expanded, and the attachment and detachment device 8 is positioned on the outside of the frame 35.

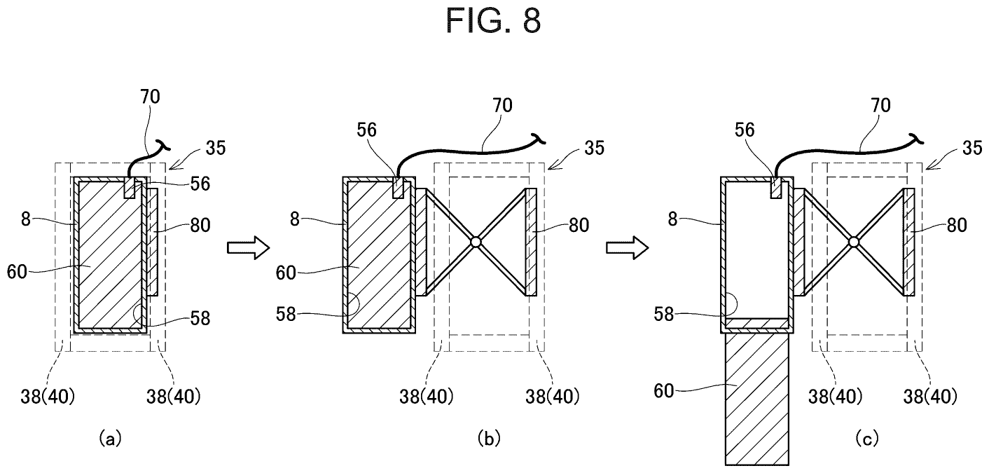

With reference to FIG. 8, an attachment and detachment method of the hydrogen tank 60 is described. FIG. 8 corresponds to FIG. 5 described for the saddle-ride vehicle 10. Here, (a) shows a state in which the attachment and detachment device 8 is positioned in a predetermined position (on the inside of the center tunnel 42). In this state, the operation of the attachment and detachment device 8 is prohibited by the lock mechanism 12. After the hydrogen in the hydrogen tank 60 is consumed, the hydrogen tank 60 is removed from the attachment and detachment device 8 in order to replace the hydrogen tank 60. First, the lock mechanism 12 is released, and the attachment and detachment device 8 is placed in an operable state.

Next, as shown in (b), the pantograph 80 is expanded, and the attachment and detachment device 8 is moved in a sliding manner until the entire attachment and detachment portion 58 is positioned on the outside of the frame 35 (frames 38, 40). The position of the opening and closing mechanism 56 with respect to the frame 35 changes, and the distance from the opening and closing mechanism 56 to the fuel cell (not shown) changes in this case as well. However, the opening and closing mechanism 56 and the fuel cell are connected to each other by the flexible pipe 70. Therefore, the flexible pipe 70 can be prevented from being disconnected from the opening and closing mechanism 56 and/or the fuel cell even when the attachment and detachment device 8 is moved.

Next, as shown in (c), the hydrogen tank 60 is pulled out from the attachment and detachment device 8. When the hydrogen tank 60 is pulled out from the attachment and detachment device 8, the opening and closing mechanism 56 is disconnected from the hydrogen tank 60, and the valve of the hydrogen tank 60 is closed. The gripping portion 62 for gripping the hydrogen tank 60 is provided in the rear side end portion of the hydrogen tank 60. When the hydrogen tank 60 is to be pulled out from the attachment and detachment device 8, the gripping portion 62 is gripped, and the hydrogen tank 60 is pulled out. Then, the hydrogen tank 60 that is new and is filled with hydrogen is inserted into the attachment and detachment device 8, and the attachment and detachment device 8 is disposed into on the inside of the frame 35 (the inside of the center tunnel 42) in the order of (c), (b), and (a).

In the saddle-ride vehicle 10a, when the hydrogen tank 60 is attached or detached, the attachment and detachment device 8 is moved to the left side of the saddle-ride vehicle 10 (b). However, the attachment and detachment device 8 may be moved to the right side of the saddle-ride vehicle 10. In the saddle-ride vehicle 10a, when the hydrogen tank 60 is pulled out from the attachment and detachment device 8, the hydrogen tank 60 is pulled out to the rear side (c). However, the opening and closing mechanism 56 may be provided on the rear side of the attachment and detachment device 8, the attachment and detachment portion 58 may be provided on the front side of the attachment and detachment device 8, and the hydrogen tank 60 may be pulled out to the front side when the hydrogen tank 60 is pulled out from the attachment and detachment device 8. Alternatively, the opening and closing mechanism 56 may be provided on the lower side of the attachment and detachment device 8, the attachment and detachment portion 58 may be provided on the upper side of the attachment and detachment device 8, and the hydrogen tank 60 may be pulled out to the upper side when the hydrogen tank 60 is pulled out from the attachment and detachment device 8. The pantograph 80 may be omitted, rails may be provided on the frame 35 (connecting frames 52, 54), and the attachment and detachment device 8 may be moved in a sliding manner until the entire attachment and detachment portion 58 is positioned on the outside of the frame 35 (frames 38, 40).

The embodiments of the present disclosure have been described in detail above, but those are merely exemplifications and do not limit the scope of claims. The technology described in the scope of claims includes those obtained by variously modifying and changing the specific examples exemplified above. The technical elements described in the present specification or the drawings exhibit a technical utility by itself or by various combinations, and are not limited to the combinations described in the claims as originally filed. The technology exemplified in the present specification or the drawings achieves a plurality of objects at the same time, and has a technical utility by achievement of one of those objects itself.

What is claimed is:

1. A saddle-ride vehicle on which a detachable and attachable hydrogen tank is mounted, wherein:
an attachment and detachment device is disposed in a place that is between a front fork and a rear suspension and that is below a seat of the saddle-ride vehicle;
the hydrogen tank is mountable on the attachment and detachment device; and
the attachment and detachment device is operable such that at least an attachment and detachment portion of the hydrogen tank is positioned outside a frame of the saddle-ride vehicle when the hydrogen tank is detached or attached.

2. The saddle-ride vehicle according to claim 1, wherein the attachment and detachment device is disposed in a center tunnel provided in the frame.

3. The saddle-ride vehicle according to claim 1, wherein the attachment and detachment device is pivotally attached to the frame.

4. The saddle-ride vehicle according to claim 1, wherein the attachment and detachment device is integrated with the seat.

5. The saddle-ride vehicle according to claim 1, wherein the attachment and detachment device is attached to be moved in a sliding manner with respect to the frame.
